(19) United States
(12) Patent Application Publication
(10) Pub. No.: US 2026/0206691 A1
(43) Pub. Date: Jul. 23, 2026

(54) MULTISPECIES CULTIVATION KIT

(71) Applicant: KN-KONTAKTO NATURA SRL, VICENZA (IT)

(72) Inventor: Lucia CARIOLATO, VICENZA (IT)

(21) Appl. No.: 19/137,318

(22) PCT Filed: Dec. 13, 2023
(86) PCT No.: PCT/IB2023/062593

§ 371 Date: Jun. 10, 2025

(30) Foreign Application Priority Data
Dec. 13, 2022 (IT) 102022000025524

(51) Int. Cl. A01G 9/029; A01G 31/02

(52) U.S. Cl. CPC A01G 9/0297; A01G 31/02

(57) ABSTRACT

The present invention is part of the field of devices that allow the cultivation of various plant species above ground or without having to have a soil on which to plant the crop, thus allowing cultivation even in environments that are not necessarily rural but also directly in the home, a possibility very favourably received by the market given the growing attention of the consumer to the quality of food, especially vegetable food, easily altered by the presence of fertilizers, pesticides, chemical fertilizers, genetic modifications. In particular, the present invention describes a complete multispecies cultivation kit to be able to cultivate a plurality of species thanks to combinations of modules of the kit itself.

The present invention is part of the field of devices that allow the cultivation of various plant species above ground or without having to have a soil on which to plant the crop, thus allowing cultivation even in environments that are not necessarily rural but also directly in the home, a possibility very favourably received by the market given the growing attention of the consumer to the quality of food, especially vegetable food, easily altered by the presence of fertilizers, pesticides, chemical fertilizers, genetic modifications.

### PRIOR ART

Devices that allow plants to sprout using different technologies have long been known: in fact, hydroponic sprouters, automatic irrigation sprouters, etc. are known, all solutions that allow the consumer to produce some plant species disadvantageously independently, however, said already known devices can take advantage of the various sprouting and cultivation techniques in a limited way, being substantially dedicated individually to a single type of cultivation and sprouting, thus considerably limiting the possibility of varieties to be cultivated with the use of a single device. In addition, said devices have grilled surfaces with a wide pitch that are poorly suited to the cultivation of particularly small seeds as well as having grid elements that allow a rather limited oxygenation of the cultivation surface, affecting the development and growth of the species. In addition, these grilled surfaces are often rigid, that is, the grid is formed by rigid elements that do not lend themselves well to cleaning and root removal at the end of the crop.

It is therefore an object of the present invention to describe a multispecies cultivation kit suitable for cultivating numerous botanical species.

A further object of the present invention is to describe a multispecies cultivation kit that is easy to use.

Still another object of the present invention is to describe a multispecies cultivation kit that can be economical in purchase and management.

A further object of the present invention is to describe a multispecies cultivation kit that can exploit different cultivation techniques.

It is still an object of the present invention to describe a multispecies cultivation kit that is modular, sectional, and expandable.

It is still an object of the present invention to describe a multispecies cultivation kit that for certain crops allows to optimize the oxygenation and drainage of the seeds.

Finally, it is an object of the present invention to describe a multispecies cultivation kit that includes elements such as grids suitable for seeds of multiple types of diameters without the need to change grids for different types of seeds.

These and further objects will be achieved by the innovative multispecies cultivation kit object of the present invention comprising one or more combination of modules such as at least one tray, at least one grid module to house seeds or elements to be cultivated, at least one lid or drainage tray module, at least one basket module or mesh pot, characterized in that the different combinations of modules being suitable at least for at least hydroponic/in water and/or substrate cultivation, wherein said modules of said kit connecting to each other in different combinations to be able to cultivate different species with different technologies in particular:
tray module+grid module+lid module for cultivation in water;
tray module+lid module+basket module for cultivation with substrate;
tray module+grey module+lid module+basket module for cultivation in water and substrate;
   and said at least one grid module comprising solid elements with a preferably rhomboidal section spaced out by empty spaces, arranged side by side to create an optimized grid surface with respect to the ratio of open-closed areas, i.e. the surface of the empty spaces being greater than the surface of the solid elements on the plane, this to allow having a ventilation and drainage surface maximized with respect to the closed areas or solid elements to allow multispecies cultivation.

These solid elements with a rhomboidal section are made of flexible plastic resin or mechanically similar materials, guaranteeing both rigidity and flexibility to be able to better clean the grid from the roots at the end of cultivation.

Said grid module comprising a peripheral protrusion to engage stably on at least one of the other tray or lid modules in the event that they are used in the initial phase of cultivation as a lid and therefore act as a mini greenhouse and support base.

Said lid module comprising at least elevations on the vertices, preferably four, so that it can be fitted onto the grid or onto the basket to act as a tray drain or cover, and a tooth on the perimeter surface to engage stably on at least one of the other modules. Said basket module comprising a bottom surface and one or more slotted side surfaces comprising prismatic elements with a triangular section arranged with at least one flat side facing outwards for optimizing oxygenation and drainage and said basket module comprising a perimeter protrusion to engage stably on at least one of the other modules. Said basket module comprising in a variant a channel for irrigation of the basket itself.

Said modules connecting to each other in different combinations to be able to cultivate different species with different technologies in particular:
tray module+grid module+lid module for cultivation in water;
tray module+lid module+basket module for cultivation with substrate;
tray module+grid module+lid module+basket module for cultivation in water and substrate.

### BRIEF DESCRIPTION OF THE DRAWINGS

FIG. 1 shows the non-assembled multispecies cultivation kit.

FIG. 2 shows the tray module component in three views.

FIG. 3 shows the grid module component in three views and a section.

FIG. 4 shows the lid module component in three views.

FIG. 5 shows the basket module component in three views.

FIG. 6 shows a variant of the basket module with water channel.

FIGS. 7a, 7b, 7c, 7d, 7e, 7f, 7g, 7h, 7i show the multispecies cultivation kit assembled for different uses.

### DESCRIPTION OF THE DRAWINGS

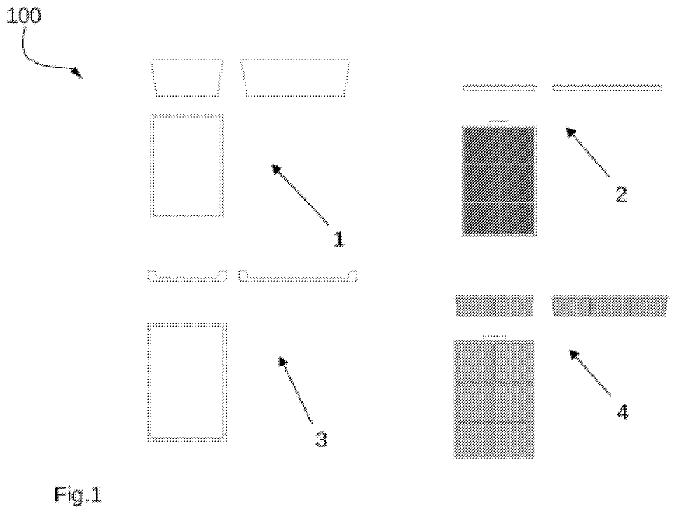

The multispecies cultivation kit 100 object of the present invention is therefore visible in FIG. 1. The modules that compose it are visible in several views, namely the tray 1, the grid 2, the lid 3, the basket 4 depending on the use. The set of these details used simultaneously all together or in a selection of them realizes as explained below the innovative features of the multispecies cultivation kit. For a detailed description of each component, please refer to the following figures.

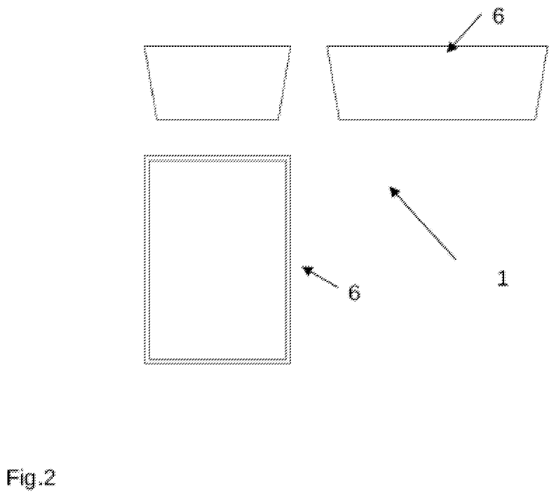

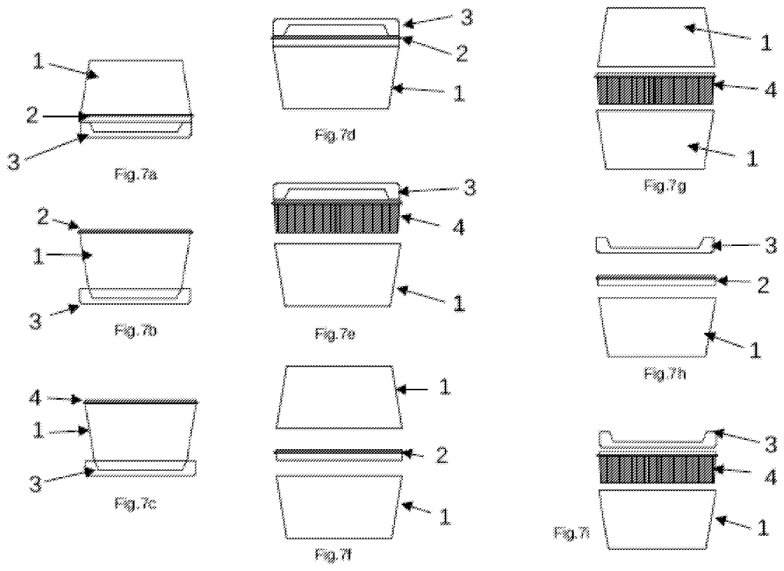

FIG. 2 therefore shows the tray module 1 which can be assimilated in this non-limiting example to a container preferably having a trapezoidal section and having different functions depending on the configuration of the multispecies cultivation kit and in particular:
the function of collecting and storing water both for hydroponic and with substrate cultivation FIGS. 7b and 7c below or
container and pot for the cultivation of non-mucilaginous sprouts see FIG. 7a below or
cover to obtain a mini greenhouse useful for maintaining the right temperature and humidity in the initial phase of seedling growth, see below. It should be noted that said tray will have suitable measures to couple with the other elements, in particular the grid 2 and the basket 4 having a special perimetric overhang to accommodate the upper edge 6 as will be illustrated later in FIG. 7 a and subsequent.

The walls will be slightly inclined to allow the stacking of several empty trays and therefore reduce the overall volume. All corners and edges will be slightly chamfered so as to avoid sharp edge.

Said tray will preferably be made of transparent plastic material with high mechanical resistance, elasticity, anti-scratch, suitable for food use.

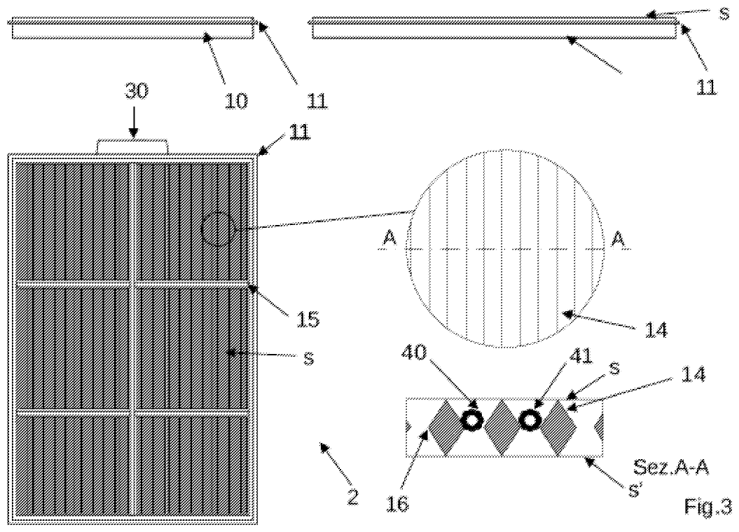

FIG. 3 shows the grid module 2 which in a completely innovative and advantageous way comprises a frame 10 on which a peripheral protrusions 11 is made to make the couplings with the other modules. The frame also supports by means of reinforcements 15 solid elements with a preferably rhomboidal section 14 arranged side by side, said solid elements may have chamfered edges. The arrangement of the solid elements 14 realizes in all respects the functional part of the grid module 2 since such an arrangement and geometry allow in a completely innovative and advantageous way to create a grid surface S formed by said solid elements 14 and by empty spaces 40, i.e. the surface S formed by open spaces 40 will be higher than the surface S formed by said solid elements 14 (i.e. by the surface of said elements 14) whereby (SupS40>SupS14).

It also includes a lower grid surface S′ identical to the upper surface S, parallel to the same that can be a support (depending on the composition of the kit).

In this embodiment, a seed 41 that is deposited on the surface S with holes 40 and closed elements 14, remains supported by the sides and corners of the rhomboidal elements close to each other, having the best open-closed ratio or a seed 41 that is deposited on the frame 10 will have minimal contact with said edges of said elements 14, most of the seed staying in the spaces 40 benefiting from maximum oxygenation and drainage fundamental characteristics for proper growth and also having an ideal support surface for the seed as it is supported adequately maintaining oxygenation. Note that, as evident from the figures, said preferably rhomboidal elements 14 have axes of symmetry orthogonal to the surface, so that the surfaces S and S′ will be “touched” by two vertices thereof, and the other vertices will be adapted, in pairs of rhomboidal elements 14, to support the seeds 41, always as visible in particular in FIG. 3.

As always visible in FIG. 3 section A-A, the vertices of two adjacent rhomboidal elements never touch each other, this obviously benefits the drainage and oxygenation of the seed, and this in a completely innovative and advantageous way compared to most common grid modules (2).

The more or less close arrangement of the filled elements 14, in particular the close edges 16 of said solid elements, may allow to grow seeds 41 even very small (for example of minimum size less than 0.7 mm) without adding, as already happens in the known art, mats to prevent the fall of the seed from the grilled surface. The two grilled surfaces S and S′ equal to each other allow the cultivation of non-mucilaginous sprouts as for example the surface S′ can have drainage and ventilation functions (see arrangement of FIG. 7a below) while the surface S can be used for the cultivation of mucilaginous sprouts, microgreens, baby leaves and others, see the arrangement of FIG. 7b below). This grid 2 in a completely innovative way also differs from other sprouters which have a substantially closed bottom or at most with few holes essential to only water drainage. In this case, however, the greatest possible drainage and oxygenation is pursued, in this regard see the prior art document KR 100 501 767.

This patent in particular describes a seedling box, and more specifically, a seedling box in which depressions and/or mountains are formed on the bottom surface and ribs are present on the outside of the bottom surface to improve flatness by improving the deformation and sagging of the bottom of the box. This is the specific cultivation of rice, where a wavy grid has been created to optimize the growth of the seedlings: in this case, a multispecies cultivation kit is not described, as only one type of element is provided for in the document for given crops, yet a substantial difference lies in the fact that the structure of the bottom of the Korean patent is practically closed. It has very few small holes (15) just to allow the drainage of excess watering water. They're basically drainage holes. As they themselves write, the holes must be few and small to prevent the roots from penetrating them and making transplant operations very difficult. In fact, they talk about reducing the working time for transplantation as the roots do not come out or come out of the holes a little, thus avoiding entanglement with consequent loss of time.

Our grid, on the other hand, is quite the opposite and indeed the Korean patent teaches the opposite, in fact in the grid of KR767 as shown in FIG. 7 there seems to be a dividing plane, this completely opposite to the present invention.

In the present invention we have tried to create as much drainage and oxygenation as possible, with total and diffuse cracking and one of the purposes as already mentioned is to make the grid compatible with most seeds (all those that exceed 7-800 seeds per gram).

Still further, the document EP 3821702 describes a sprouters tray that allows for faster germination, easier sprout extraction, and easier cleaning. The tray has a bottom provided with a plurality of through openings which are defined by two upper side surfaces in the shape of a “V” and by two lower side surfaces in the shape of an inverted “V”. The inclined surfaces offer a greater contact surface for the seeds, improving water exchange and promoting faster germination. The “V” shape of the openings also helps prevent root breakage when the sprouts are harvested. The protruding portions on the upper surface of the tray prevent the seeds from resting on the flat surface between two openings. The curvilinear shape of the openings makes it even easier to extract the sprouts without damaging the roots.

The first substantial difference is that EP702 speaks exclusively of sprouts, it is a “monovalent” sprouter. The present invention describes a “bivalent” sprouter product (both Jar and level as an expert in the field will be evident from the examples in FIG. 7, but it is also a multifunctional kit that allows to grow microgreens, baby leaves, aromatic and others in hydroponics or with substrate, this being completely innovative with respect to EP702.

Moreover, the shape of the grid of the EP702 patent is completely different from that of the present invention which instead entails all the aforementioned advantages, also this aspect being new and inventive with respect to the documents cited herein.

It is also noted that said rhomboidal elements 14 can be made, for example, of plastic resin or materials with similar mechanical characteristics that will guarantee the necessary structural rigidity but also a certain degree of flexibility, both of which are very important to facilitate the cleaning of the grid from the roots at the end of cultivation. The frame 10 also has along its entire outer surface peripheral protrusions 11 suitable for coupling stably with the tray module and/or the lid module as shown for example in FIG. 7f below. Said grid module also has a gripping flap 30 for easy gripping and handling.

Said grid module 3 is therefore used in combination with the tray module 1 and the lid module 3 for:
the cultivation of sprouts with non-mucilaginous seeds. In this case the grid acts as ventilation and drainage with the tray 1 turned over onto it, see FIG. 7 a below.
the cultivation of sprouts with mucilaginous seeds with the basic function of growth with seeds for example larger than 0.6 mm, without the use of other elements such as mats of various types as shown in FIG. 7b below.
the cultivation in water (hydroponics) of many varieties of microgreens, baby leaves and other FIG. 7b.

Said grid module can be produced in various sizes, possibly to be used side by side in several units on the same tray module so as to be able to produce different botanical species; finally, seeds or inert substrates or mats of different materials (coconut, bamboo, cellulose, hemp, cotton and others) can be laid directly on the grid surfaces S, depending on the position of the grid element, thus considerably increasing the functionality compared to the known art. It should be noted that the grid can in all respects, as described, engage stably or snap on the tray, remaining fixed to it in order to avoid, in the rinsing and drainage phase or when the cultivation kit must be inverted to let the water out, that the grid itself can leave its seat in the tray and then let the seeds or sprouts out. This is all to the advantage of a water emptying operation that can be carried out more easily and safely with just one hand.

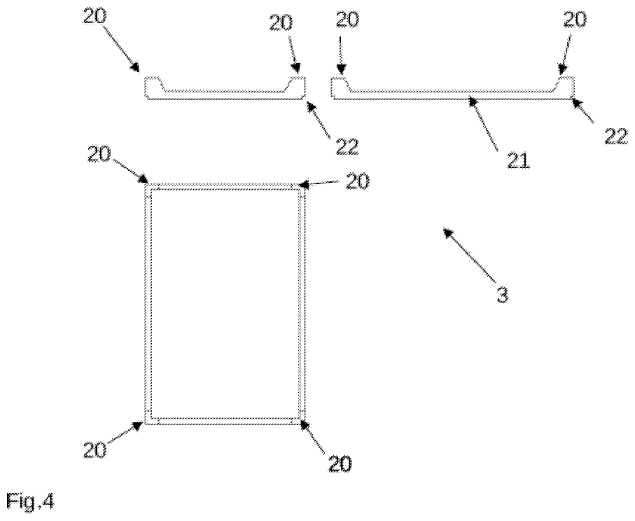

FIG. 4 shows the lid module 3 comprising a substantially flat plate 21 at the vertices of which risers 20 are made that will allow a gap to be created between said plate 21 and a module placed on it resting on the risers 20 (FIGS. 7a, 7d, 7e later in the description). A tooth 22 is made on the perimeter surface 21 to innovatively house the grid module or the basket module. The lid module 3 therefore performs different functions depending on the case:
it is used as a drainage tray in the case of the production of sprouts from non-mucilaginous seeds. It is used for the recovery of drainage water after the seed rinsing phase. It allows at the same time the ventilation of the sprouts and the possibility of stacking the different kits on each other and thus saving space, positioning as in FIG. 7a with grid module and tray module stacked on top.
it is used instead as a cover in the darkening phase (blackout), both in the case of cultivation in water and with substrate. Most seeds grow and root better if left, for a variable period of 2-7 days, depending on the type, in the dark in an environment with a high percentage of humidity and the right temperature. Positioning convex above the grid module or the basket module as in FIGS. 7h and 7i.
again as a low lid used as a mini greenhouse or to be able to stack various cultivation kits on top of each other in the initial phase of seedling growth and thus save space. In this case, is positioned concave above the grid module or basket module as can be seen later in FIGS. 7d and 7e.

Last but not least, when it is not used in one of the functions described above because in some life cycles of the seedlings it is not needed, it can be stored under the tray module with base functionality obtaining a considerable saving of space saving space (FIGS. 7b and 7c below).

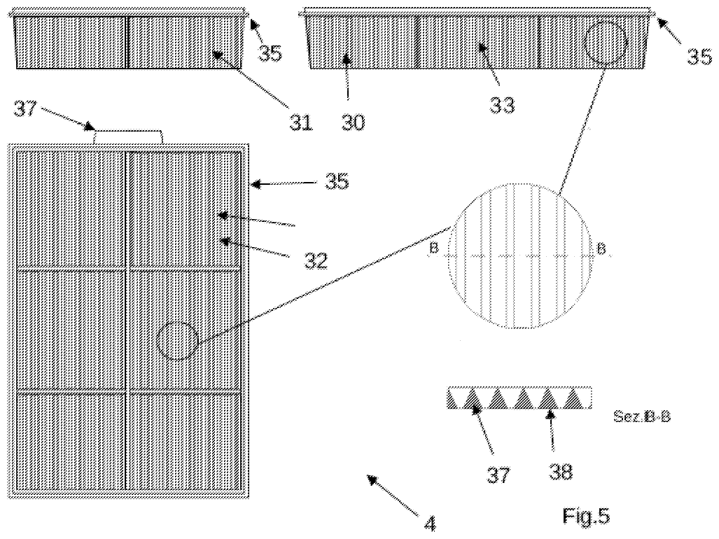

FIG. 5 therefore shows the basket module 4 suitable to be combined with the tray module 1 and the lid module 3 for cultivation with any type of substrate, inert or not. In a completely innovative way, said basket 4 comprises a bottom surface 32 and side slotted surfaces 30 and 31 or made with alternation of full and empty parts, the full parts are made with preferably full elements 33 with a preferably triangular section 37 arranged with one side of the triangle of section (for example the base) 38 facing outwards said full triangular elements spaced apart from each other by a space that in an embodiment and non-limiting example can be indicated with about 1.2 mm.

This particular structure, with “triangular ribs”, of the inner surface of the basket has the advantage of guiding the roots of the plants outwards and thus facilitating access to water and oxygen. The figure then shows the perimetric protrusion 35 to allow stable coupling with the tray and lid modules, for example if these are used, in the initial phase of cultivation, as a lid to create a sort of small greenhouse or support base (FIGS. 7g and 7e below).

There is then a flap 37 to be able to grasp and move the basket module 4 in the best possible way. It should be noted that the dense and widespread fissures present on the bottom and sides of the basket module allows, in an advantageous way, as well as an excellent oxygenation and drainage of the roots, to avoid spyralization of the same. The coupling of the tray module 1 with the basket module is thus particularly innovative, creating a further novelty represented by a slotted vase inserted in a completely closed container. Small pieces of fabric (cotton, linen or other) can be inserted on the bottom of the basket module 4, which, thanks to their water capillarity property, allow sub-irrigation.

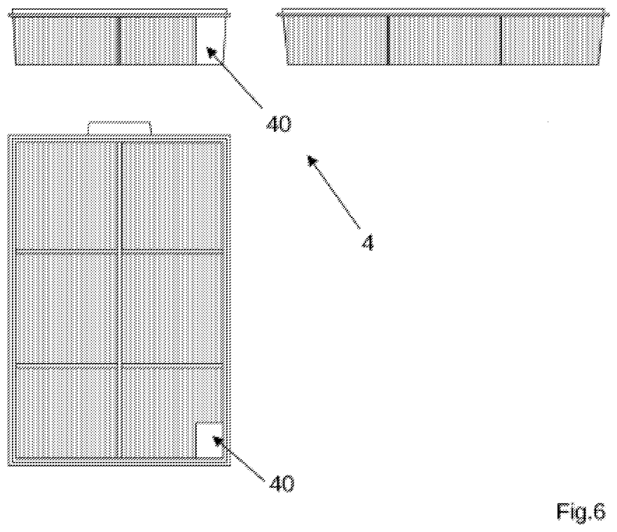

FIG. 6 shows a variant of the basket module comprising a channel 40 to facilitate the pouring of water, in the case of cultivation with substrate, without wetting the soil surface and therefore allowing sub irrigation. By means of said channel, for example, stuck on a part (of the bottom and/or side) of the basket module, the opportunity is created to be able to pour the water directly into the tray module. The channel element 40 can be useful for a single use or with multiple basket modules in order to speed up and simplify irrigation. Said channel 40 also allows irrigation to be pursued from below and a water reserve to be obtained.

The seedlings therefore do not have to be irrigated daily but can remain autonomous for many days. The duration of the autonomy depends on the type of plant, the temperatures, and the growth phase.

Finally, FIG. 7a-7i show examples of the use of the innovative multispecies cultivation kit already mentioned above and summarised here in various combinations.

FIG. 7a shows a combination of modules for the present kit for the cultivation of non-mucilaginous sprouts modules (1+2+3), in this case the grid 2 acts as ventilation and drainage with the tray 1 upside down.

FIG. 7b shows a combination of modules of the present kit (2+1+3) for the cultivation in water (hydroponics) of many varieties of microgreens, baby leaves and others.

FIG. 7c,e,g,i show forms of kit assembly with modules (1+3+4) in a plurality of possible configurations/combinations suitable for—microgreens, baby leaves and others with various types of substrate, inert and non-inert, such as: soil, peat, various mixtures, coconut, perlite, vermiculite, expanded clay and others. It is classic and traditional cultivation.

Finally, FIG. 7d shows a combination of modules (3+2+1)—suitable for a mini greenhouse useful for maintaining the right temperature and humidity in the initial phase of seedling growth. This functionality is made possible thanks to the shape already described and the inclinations of the walls of tray 1 as well as a special edge prepared both module 2 and 4 which acts as a seat and joint. With this use it is also possible to stack different products on top of each other.

It is therefore clear that all the objectives are achieved and achieved with the innovative multispecies cultivation kit object of the present invention suitable for cultivating numerous botanical species, it being evident how easy it is to use the kit with the rapid and intuitive arrangement of the various modules, not only that, at the same time the economy of the same modules allows a low economic commitment obtaining the possibility of cultivating a vast range of botanical species adopting very different types of cultivation (hydroponic and traditional multifunction kit that allows you to grow microgreens, baby leaves, aromatic and others in hydroponics or with substrate) with the same kit.

1. A multispecies cultivation kit system comprising one or more combinations of modules such as at least one tray (1), at least one grid module (2) for housing seeds or elements to be grown, at least one lid or drainage tray module (3), at least one basket module or mesh pot (4), characterized in that the different combinations of modules (1,2,3,4) being suitable at least for at least hydroponic/in water and/or substrate cultivation, wherein said modules of said kit (1 and/or 2 and/or 3 and/or 4) connecting to each other in different combinations to be able to cultivate different species with different technologies in particular:
tray module (1)+grid module (2)+lid module (3) for cultivation in water;
tray module (1)+lid module (3)+basket module (4) for cultivation with substrate;
tray module (1)+grid module (2)+lid module (3)+basket module (4) for cultivation in water and substrate;
and said at least one grid module (2) comprising solid elements (14) with a preferably rhomboidal section spaced out with empty spaces (40), arranged side by side thus creating an optimized grid surface(S) with respect to the ratio of open-closed areas, i.e. the surface of the empty spaces (40) being greater than the surface of the full elements (14) on the plane(S), (SupS40 >SupS14), this to allow having a ventilation surface(S) and maximized drainage with respect to the closed areas or solid elements (14).

2. The multispecies cultivation kit system according to claim 1, wherein said solid elements with rhomboidal section (14) being made of flexible plastic resin or mechanically similar materials conferring both rigidity and flexibility to be able to better clean the grid from the roots at the end of cultivation.

3. The multispecies cultivation kit system according to the preceding claims, wherein said grid module (2) comprises a frame (10) on which a perimeter protrusion (11) is made to make the couplings with the other modules (1, 3 or 4), said frame (10) also supports by means of reinforcements (15) said solid elements with preferably rhomboidal section (14), the surface(S) having an equal support surface (S') parallel to it, always to optimize oxygenation and drainage.

4. The multispecies cultivation kit system according to the preceding claims, wherein a seed (41) that is deposited above the surface(S) with holes (40) and solid elements (14), remains supported by the edges of the rhomboidal elements close to each other, having the best open-closure ratio or a seed (41) that is deposited above on the frame (10) will have minimal contact with said edges of said elements (14) most of the seed lodging in the spaces (40) benefiting from maximum oxygenation and drainage fundamental characteristics for correct growth.

5. The multispecies cultivation kit system according to the preceding claims, wherein the vertices of the rhomboidal elements (14) that are adapted to support or house the seeds (41) do not touch each other, thus leaving an open space for better drainage and oxygenation.

6. The multispecies cultivation kit system according to the preceding claims, wherein the more or less close arrangement of the solid elements (14), in particular of the edges (16) of the rhomboidal elements may allow to cultivate even very small seeds—for example of minimum size less than 0.7 mm—without the addition of mats to prevent the fall of the seed from the grilled surface, said seeds being supported by the edges (16) of the preferably rhomboidal elements.

7. The multispecies cultivation kit system according to the preceding claims, wherein the two equal grilled surfaces (S and S') allow the cultivation of non-mucilaginous sprouts as the surface (S') can have drainage and ventilation functionality, while the surface(S) can be used for the cultivation of mucilaginous sprouts, microgreens, baby leaves and others, said grid being therefore suitable for multispecies cultivation.

8. The multispecies cultivation kit system according to the preceding claims, wherein the frame (10) also has along its entire external surface peripheral protrusions (11) suitable for stably coupling with the tray module (1) and/or the lid module (3), said grid module (2) also has a gripping flap (30) to facilitate its gripping and management.

9. The multispecies cultivation kit system according to the preceding claims, wherein said lid module (3) comprising at least elevations on the vertices, preferably four, so that it can be fitted onto the grid (2) or on the basket (4) to act as a drainage tray or lid, and a tooth on the perimeter surface to engage stably on at least one of the other modules.

10. The multispecies cultivation kit system according to the preceding claims, wherein said basket module (4) comprising a bottom surface and one or more slotted side surfaces comprising prismatic elements with a triangular section arranged with at least one flat side facing outwards for optimizing oxygenation and drainage and said basket module (4) comprising a perimetric protrusion to engage stably on at least one of the other modules, said basket module (4) comprising in a variant a channel for irrigation of the basket itself.

11. The multispecies cultivation kit system according to the preceding claims, wherein said grid module (2) is used in combination with the tray module (1) and the lid module (3) for:
the cultivation of sprouts with non-mucilaginous seeds, in this case the grid (2) acts as ventilation and drainage with the tray (1) turned over onto it;
the cultivation of sprouts with mucilaginous seeds with the basic function of growth with seeds for example of a size greater than 0.6 mm, avoiding the use of other elements such as mats of various types as shown in FIG. 7b below.
the cultivation in water (hydroponics) of many varieties of microgreens, baby leaves and more.
